(19) United States
(12) Patent Application Publication
(10) Pub. No.: US 2012/0206578 A1
(43) Pub. Date: Aug. 16, 2012

(54) APPARATUS AND METHOD FOR EYE CONTACT USING COMPOSITION OF FRONT VIEW IMAGE

(76) Inventors: Seung Jun YANG, Daejeon (KR); Han Kyu LEE, Daejeon (KR); Ji Hun CHA, Daejeon (KR); Jin Woong KIM, Daejeon (KR); Sang Beom LEE, Gwangju (KR); In Yong SHIN, Gwangju (KR); Yu Sung HO, Gwangju (KR)

(21) Appl. No.: 13/396,865

(22) Filed: Feb. 15, 2012

(30) Foreign Application Priority Data
Feb. 15, 2011 (KR) 10-2011-0013150
Nov. 7, 2011 (KR) 10-2011-0114965

(51) Int. Cl. H04N 13/02

(52) U.S. Cl. 348/47; 348/E13.074

(57) ABSTRACT

Provided is an apparatus and method for an eye contact using composition of a front view image, the apparatus including: an image acquiring unit to acquire a multi-camera image; a preprocessing unit to preprocess the acquired multi-camera image; a depth information search unit to search for depth information of the preprocessed multi-camera image; and an image composition unit to compose the front view image using the found depth information.

### CROSS-REFERENCE TO RELATED APPLICATIONS

This application claims the priority benefit of Korean Patent Application No. 10-2011-0013150, filed on Feb. 15, 2011, and Korean Patent Application No. 10-2011-0114965, filed on Nov. 7, 2011, in the Korean Intellectual Property Office, the disclosures of which are incorporated herein by reference.

### BACKGROUND

1. Field of the Invention

The present invention relates to a method and apparatus for an eye contact using a multi-camera for an eye contact between speakers in the case of a video conference and a video phone.

2. Description of the Related Art

“Three dimension (3D) has created renaissance of digital media and 3D is a remarkable moment in the history of entertainment” said James Cameron who has drawn the global attention towards 3D through the massive success of film “avatar” at the 2010 Seoul Digital Forum.

The speech of the director James Cameron who has played an important role in igniting a currently surprisingly increasing 3D market matches the prospect that digital media will bring another revolution of a visual industry converting from two dimension (2D) to 3D in the near future, as the great change is brought to the visual industry while a broadcasting system is converted from analog to digital.

As a matter of fact, advanced countries are creating 3D image contents for 3D broadcasting and 3D experimental broadcasting is being prepared even in Korean based on a plurality of broadcasting providers.

Currently, a moving picture experts group (MPEG) international organization for standardization (ISO) has defined a 3D video system, and is working on an international standardization of compressing and encoding a 3D video including a multi-view color image and a multi-view depth image.

The 3D video system defined in an MPEG indicates a high resolution 3D video system that may provide three or more views of wide viewing angle.

To configure the 3D video system, a technology of estimating a depth image that expresses distance information of a 3D scene using a multi-view image of a wide viewing angle acquired from a plurality of cameras and an intermediate view image composing technology that enables a user to view a scene at a desired view using a depth image may be used.

FIG. 1 is a diagram illustrating a 3D video system configured in an MPEG.

As shown in FIG. 11, among key technologies of the 3D video system, a depth search technology and an image composition technology may be used for various application fields. A representative example is an eye contact technology for a remote video conference.

Currently, the Heinrich Hertz Institute (HHI) of Germany has developed a 3D remote video conference system using the aforementioned major technologies.

The 3D remote video conference system may search for depth information of a speaker using four cameras and enable an eye contact between speakers using an image composition process. However, in this case, compared to a performance, a hardware configuration may be very complex and a great amount of costs may be used for a system construction.

### SUMMARY

According to an aspect of the present invention, there is provided an apparatus for an eye contact using composition of a front view image, the apparatus including: an image acquiring unit to acquire a multi-camera image; a preprocessing unit to preprocess the acquired multi-camera image; a depth information search unit to search for depth information of the preprocessed multi-camera image; and an image composition unit to compose the front view image using the found depth information.

According to another aspect of the present invention, there is provided a method for an eye contact using composition of a front view image, the method including: acquiring, by an image acquiring unit, a multi-camera image using two stereo cameras that are arranged in a convergent form; preprocessing, by a preprocessing unit, the acquired multi-camera image; searching, by a depth information search unit, for depth information of the preprocessed multi-camera image; and composing, by an image composition unit, the front view image using the found depth information.

### Effect

According to embodiments, it is possible to significantly decrease cost compared to a commercial product based on a physical characteristic of a camera.

Also, according to embodiments, it is possible to provide a maximally natural front view image by applying an intermediate view image composition technology.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a three dimensional (3D) video system configured in a motion picture experts group (MPEG);

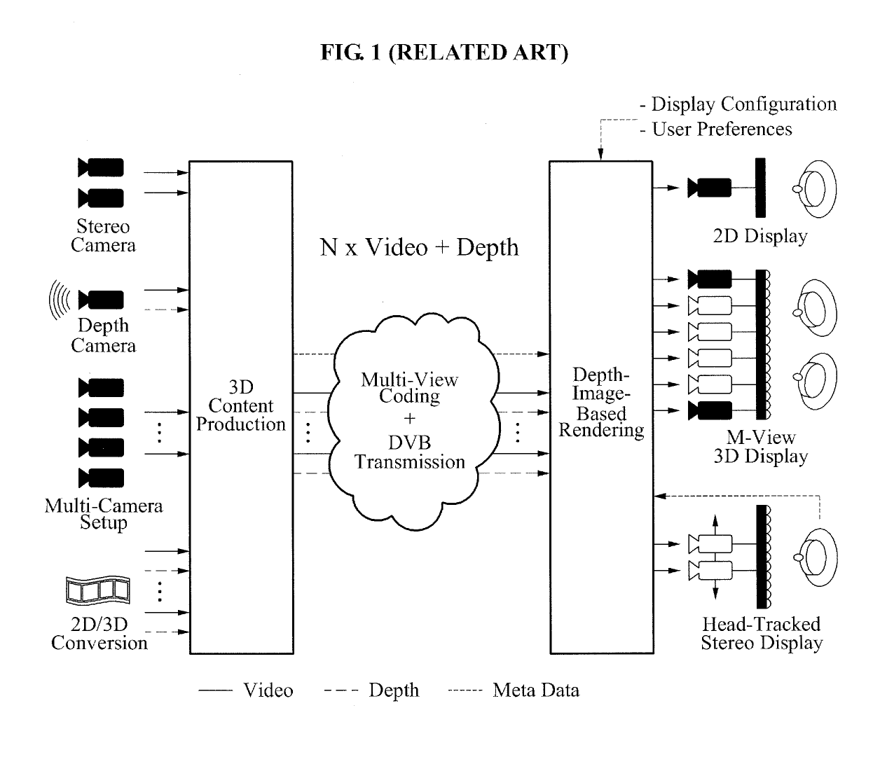

FIG. 2 is a block diagram illustrating an apparatus for an eye contact using composition of a front view image according to an embodiment of the present invention;

FIG. 3 is a flowchart illustrating a method for an eye contact using composition of a front view image according to an embodiment of the present invention;

FIG. 4 is a diagram to describe an image composition method according to an embodiment; and

FIG. 5 is a flowchart illustrating a method for an eye contact using composition of a front view image according to another embodiment of the present invention.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

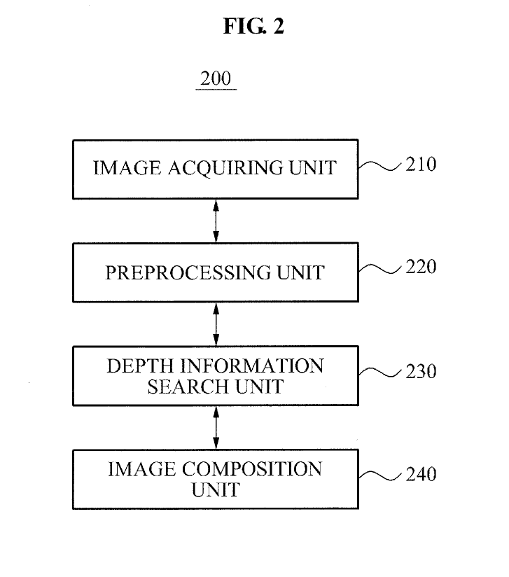

FIG. 2 is a block diagram illustrating an apparatus 200 (hereinafter, an eye contact apparatus) for an eye contact using composition of a front view image according to an embodiment of the present invention.

The eye contact apparatus 200 according to an embodiment of the present invention may propose a method for an eye contact using composition of the front view image.

Specifically, unlike a conventional art, the eye contact apparatus 200 may compose a front view image using two stereo cameras arranged in a convergent form. According to a front view image composition method, it is possible to acquire an image as if a speaker views the front.

For the above purpose, the eye contact apparatus 200 may include an image acquiring unit 210, a preprocessing unit 220, a depth information search unit 230, and an image composition unit 240.

The image acquiring unit 210 may acquire a multi-camera image.

The image acquiring unit 210 may acquire the multi-camera image using two stereo cameras that are arranged in a convergent form.

The preprocessing unit 220 may preprocess the acquired multi-camera image.

Once the multi-camera image is acquired by photographing a speaker, the is preprocessing unit 220 may perform an image preprocessing process such as a camera parameter obtainment and a camera rectification.

For example, the preprocessing unit 220 may perform a multi-view image rectification by calculating a conversion equation using an obtained camera parameter and applying the calculated conversion equation to each view image.

Camera calibration is a technology of predicting a camera parameter and may calculate an internal camera parameter and an external camera parameter based on feature points extracted from a plurality of two dimensional (2D) images photographed in a grid pattern.

The internal camera parameter may be expressed by a matrix including values that indicate internal characteristics of a camera, for example, a focal distance of the camera and the like. The external camera parameter may include a motion vector and a rotation vector that indicate a position and a direction of the camera in a 3D space.

Using the internal camera parameter and the external camera parameter, it is possible to calculate a projection matrix of the camera. The projection matrix may function to move a single point in the 3D space to a single point on a 2D image plane.

The camera parameter and the camera projection matrix obtained through the camera calibration may be essential information that is most basic in 3D image processing and application, and may be used to perform calibration, for example, correction with respect to all of a plurality of cameras when the plurality of cameras is used.

In general, a geometrical error may exist in an image that is photographed using the plurality of cameras. The error may occur since the plurality of cameras is manually arranged. Therefore, vertical coordinates of correspondence points of respective view images and a disparity into a horizontal direction between the correspondence points may inconsistently appear.

Even though the same camera is used, an error may exist between internal camera parameters obtained through the camera calibration. Such error may degrade the quality in generating a depth image and composing an intermediate view image.

The multi-view image rectification performed by the preprocessing unit 220 may be understood as an operation of minimizing a geometrical error by applying, to each view image, the conversion equation that is obtained using the camera parameter.

The preprocessing unit 220 may predict an optical axis of a camera from the camera parameter through the multi-view image rectification, and may rectify a not-rectified optical axis using an image rectification method.

The rectified multi-view image may have only a disparity into the horizontal direction without inconsistency into the vertical direction between correspondence points.

The depth information search unit 230 may search for depth information of the preprocessed multi-camera image.

The depth image indicates an image in which 3D distance information of objects present within the image are expressed as eight bits. Also, a pixel value of the depth image may indicate depth information of each corresponding pixel.

The depth image may be directly acquired using a depth camera, and may also be acquired using a stereo camera and a multi-view camera. When the depth image is acquired using the stereo camera and the multi-view camera, the depth image may be acquired through computational estimation.

To acquire a multi-view depth image, a stereo matching technology of computationally searching for depth information using correlation between views of the multi-view image may be most widely used.

The stereo matching technology is a technology of acquiring depth information by calculating a horizontal movement level, that is, a disparity of an object between neighboring two images. The stereo matching technology may acquire depth image without using a predetermined sensor and thus, may use a relatively small amount of cost and may acquire depth information even with respect to an already photographed image.

To calculate a disparity value, with respect to all of the pixels included in a left image that is a reference image, there is a need to search for pixels of a right image that are positioned in the same positions as the pixels of the left image. For the above operation, a matching function may be used. The matching function may indicate an error value when comparing two pixels corresponding to two views. A probability that two pixels may be positioned in the same position may increase according to a decrease in an error value. The matching function for depth search may be defined as Equation 1, Equation 2, and Equation 3:

$$\begin{matrix}E ( x , y , d ) = {E}_{data} ( x , y , d ) + λ {E}_{smooth} ( x , y , d ) & [ Equation 1 ] \\ {E}_{data} ( x , y , d ) = \vert {I}_{L} ( x , y ) - {I}_{R} ( x - d , y ) \vert & [ Equation 2 ] \\ {E}_{smooth} ( x , y , d ) = {\sum }_{( {x}_{i} , {y}_{i} ) ∈ {N}_{p}}^{ } \vert D ( x , y , d ) - D ( {x}_{i} , {y}_{i} , d ) \vert & [ Equation 3 ]\end{matrix}$$

Here, (x,y) denotes coordinates of a pixel of an image for comparison, and d denotes a depth value to be obtained within a search range.

E_{data}(x,y,d) denotes a difference between a pixel value of the left image and a pixel value of the right image.

Eₛₘₒₒₜₕ(x,y,d) denotes a difference between depth values of neighboring pixels within the depth image.

The depth information search unit 230 may search for a depth image with respect to each of a left view and a right view using the matching function as shown in Equation 1, Equation 2, and Equation 3.

The image composition unit 240 may compose a front view image using the found depth information.

The image composition unit 240 may compose the front view image through the following three operations.

First, the image composition unit 240 may perform a view shift process.

Here, the view shift may indicate a method of projecting a color image towards a virtual view that is positioned in the middle of two views using the found depth information.

Second, the image composition unit 240 may perform an image integration process.

Due to the view shift, an area absent at a reference view may appear as a hole. Here, the hole may be mostly filled through the image integration process performed to integrate, into a single image, two images that are shifted from left and right reference screens to an intermediate view.

Third, the image composition unit 240 may fill a hole remaining during the image integration process, using image interpolation or inpainting.

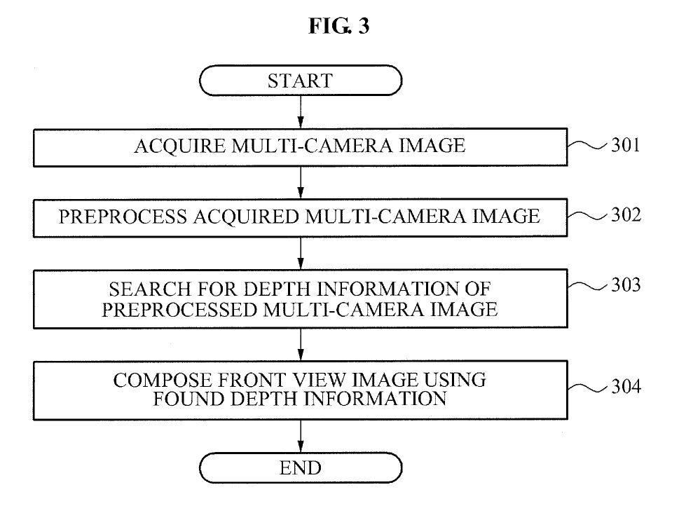

FIG. 3 is a flowchart illustrating a method (hereinafter, an eye contact method) for an eye contact using composition of a front view image according to an embodiment of the present invention.

In operation 301, the eye contact method may acquire a multi-camera image from two stereo cameras arranged in a convergent form using an image acquiring unit.

In operation 302, the eye contact method may preprocess the acquired multi-camera image using a preprocessing unit.

As one example, to preprocess the acquired multi-camera image, the eye contact method may perform at least one of a camera parameter obtainment and a camera rectification.

As another example, to preprocess the acquired multi-camera image, the eye contact method may perform a multi-view image rectification of obtaining a camera parameter, calculating a conversion equation using the obtained camera parameter, and applying the calculated conversion equation to each view image.

In operation 303, the eye contact method may search for depth information of the preprocessed multi-camera image using a depth information search unit.

To search for depth information of the preprocessed multi-camera image, the eye contact method may calculate a distance between a camera and a speaker using the found depth information.

In operation 304, the eye contact method may compose a front view image based on the found depth information using an image composition unit.

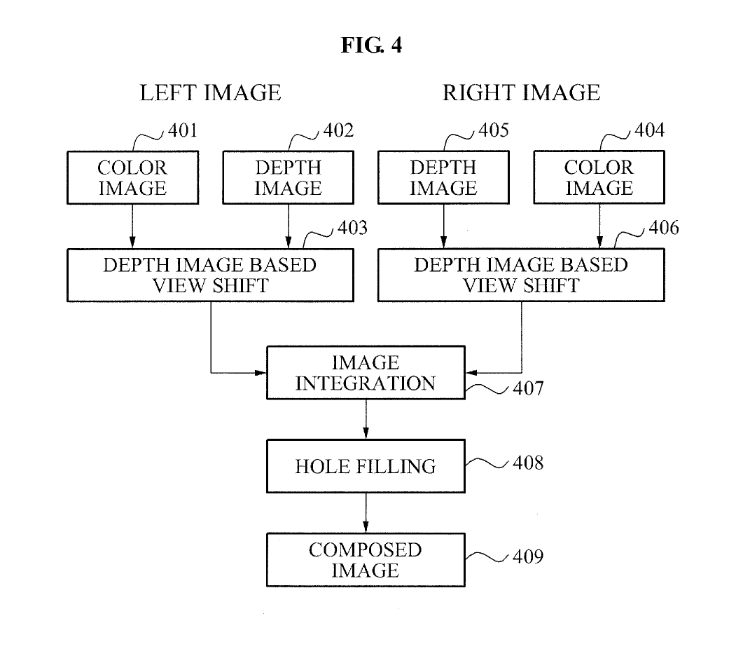

FIG. 4 is a diagram to describe an image composition method according to an embodiment.

Through operations 401 through 406, the image composition method may shift a view.

Specifically, in operation 403, the image composition method may perform a depth image based view shift with respect to a color image of a left image that is generated in operation 401 and a depth image of the left image that is generated in operation 402.

Similarly, in operation 406, the image composition method may perform the depth image based view shift with respect to a color image of a right image that is generated in operation 404 and a depth image of the right image generated in operation 405.

Due to the view shift, an area absent at a reference view may appear as a hole and thus, the image composition method may perform an image integration to fill the hole in operation 407.

The hole may be mostly filled through operation 407 performed to integrate, into a single image, two images that are shifted from left and right reference screens to an intermediate view.

In operation 408, the image composition method may fill a remaining hole using image interpolation or inpainting.

In operation 409, the image composition method may generate the completely composed image.

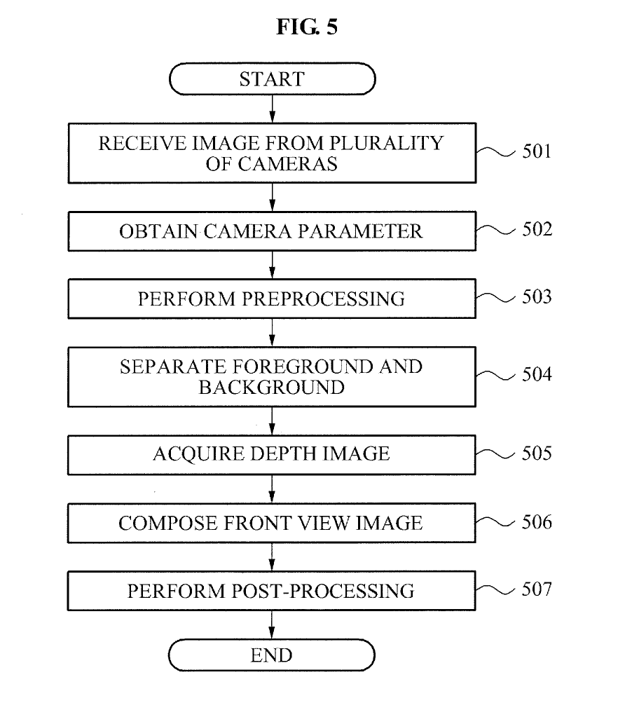

FIG. 5 is a flowchart illustrating a method for an eye contact using composition of a front view image according to another embodiment of the present invention.

In operation 501, the eye contact method may receive an image from a plurality of cameras connected to a server.

In operation 502, the eye contact method may obtain a camera parameter from the input image according to a camera characteristic.

In operation 503, the eye contact method may perform preprocessing such as a camera rectification using the camera parameter and a rectification of a parallel plane based on a camera convergence angle.

In operation 504, the eye contact method may separate a foreground, for example, a human and a background in order to decrease an amount of calculations.

In operation 505, the eye contact method may acquire a depth image minimizing a matching error by searching for depth information of each image.

In operation 506, the eye contact method may compose an image based on the depth image. In operation 507, the eye contact method may perform post-processing, for example, calibration or correction of a composed front view image.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for an eye contact using composition of a front view image, the apparatus comprising:
an image acquiring unit to acquire a multi-camera image;
a preprocessing unit to preprocess the acquired multi-camera image;
a depth information search unit to search for depth information of the preprocessed multi-camera image; and
an image composition unit to compose the front view image using the found depth information.

2. The apparatus of claim 1, wherein the image acquiring unit acquires the multi-camera image using two stereo cameras that are arranged in a convergent form.

3. The apparatus of claim 1, wherein the preprocessing unit performs at least one of a camera parameter obtainment and a camera rectification.

4. The apparatus of claim 3, wherein the preprocessing unit performs a multi-view image rectification of calculating a conversion equation using a camera parameter and applying the calculated conversion equation to each view image.

5. The apparatus of claim 1, wherein the depth information search unit calculates a distance between a camera and a speaker using the found depth information.

6. A method for an eye contact using composition of a front view image, the method comprising:
acquiring, by an image acquiring unit, a multi-camera image using two stereo cameras that are arranged in a convergent form;
preprocessing, by a preprocessing unit, the acquired multi-camera image;
searching, by a depth information search unit, for depth information of the preprocessed multi-camera image; and
composing, by an image composition unit, the front view image using the found depth information.

7. The method of claim 6, wherein the preprocessing comprises performing at least one of a camera parameter obtainment and a camera rectification.

8. The method of claim 6, wherein the preprocessing comprises:
obtaining a camera parameter;
calculating a conversion equation using the obtained camera parameter; and
performing a multi-view image rectification of applying the calculated conversion equation to each view image.

9. The method of claim 6, wherein the searching comprises calculating a distance between a camera and a speaker using the found depth information.
